(19) United States
(12) Patent Application Publication
(10) Pub. No.: US 2013/0148339 A1
(43) Pub. Date: Jun. 13, 2013

(54) PORTABLE LIGHT SOURCE

(71) Applicant: Matthew D. Noble, Los Angeles, CA (US)

(72) Inventor: Matthew D. Noble, Los Angeles, CA (US)

(21) Appl. No.: 13/316,481

(22) Filed: Dec. 10, 2011

(51) Int. Cl. F21V 21/26; F21L 4/00; F21L 4/02

(52) U.S. Cl. 362/184; 362/190; 362/249.04; 362/249.08

(57) ABSTRACT

A lighting device including at least one light source. A flexible arm is attached to the light source. A light source body is attached to the flexible arm. The light source body rotates for multi-positional lighting.

### BACKGROUND

1. Field

The embodiments relate to lighting sources, and in particular to portable attachable light sources.

2. Description of the Related Art

A person working in dark areas or at night typically requires the use of a light source, such as a flashlight or lamp. Using a lamp is sometimes inappropriate due to the working area. Carrying the extra weight of a flashlight or use of a flashlight may be inconvenient, especially when a person is working with their hands or maybe is working on a ladder or suspended by safety equipment.

### SUMMARY

One embodiment of the invention includes a lighting device. The lighting device including at least one light source. A flexible arm is coupled to the light source. A light source body is coupled to the flexible arm. The light source body rotates for multi-positional lighting.

Another embodiment of the invention comprises a system. The system includes a light source. A switch device is coupled to the light source. A power source is coupled to the switch. A flexible extension arm is coupled to the light source. A light source body is coupled to the flexible arm. The light source body rotates for multi-positional lighting.

Other aspects and advantages of the present invention will become apparent from the following detailed description, which, when taken in conjunction with the drawings, illustrate by way of example the principles of the invention.

### BRIEF DESCRIPTION OF THE DRAWINGS

The embodiments are illustrated by way of example, and not by way of limitation, in the Figures of the accompanying drawings and in which like reference numerals refer to similar elements and in which:

FIG. 1 illustrates a perspective view of a light source device according to one embodiment of the invention;

FIG. 2 illustrates a perspective view of a light source device shown with the light source and extension arm moving to a first position for lighting according to one embodiment of the invention;

FIG. 3 illustrates a perspective view of a light source device shown with the light source and extension arm moving to a second position for lighting according to one embodiment of the invention;

FIG. 4 illustrates a circuit diagram for a light source according to one embodiment of the invention;

FIG. 5 illustrates a bottom view of a light source including a clip attachment according to another embodiment of the invention; and

FIG. 6 illustrates a rear view of a light source including a clip attachment according to another embodiment of the invention.

### DETAILED DESCRIPTION

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The description may disclose several preferred embodiments of portable light sources, as well as operation and/or component parts thereof. While the following description will be described in terms of portable light sources and devices for clarity and to place the invention in context, it should be kept in mind that the teachings herein may have broad application to all types of systems, devices and applications.

One embodiment of the invention provides a portable lighting device. The lighting device including at least one light source. A flexible arm is coupled to the light source. A light source body is coupled to the flexible arm. The light source body rotates for multi-positional lighting. In one example, a clip or other attachment device attached with the portable lighting device may be attached to suspenders, a tool bag, a belt, etc. The flexible arm rotates and extends away from the light source body providing light in any direction a user desires, while the user may maintain free hands without having to hold the light source.

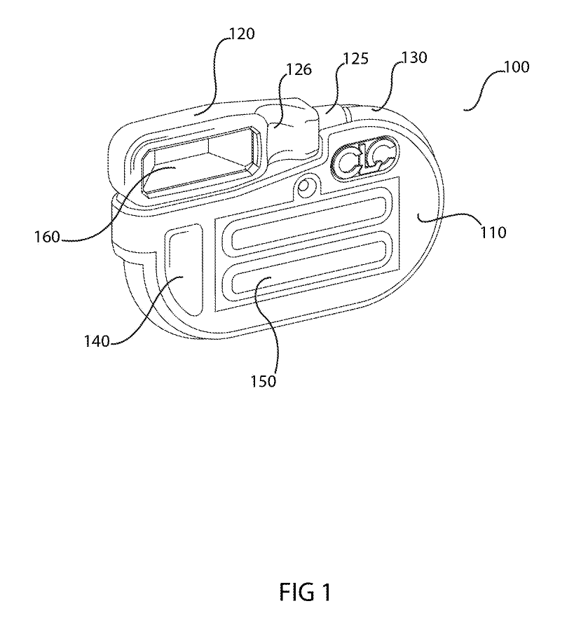

FIG. 1 illustrates a portable lighting source 100 according to one embodiment of the invention. In one embodiment of the invention, the lighting source 100 includes a housing 110, a lighting source body 120 including a coupling portion 125, a gripping (groove) portion 126 and a lighting element 160. In one example, the lighting element 160 includes one or more light emitting diodes (LEDs), such as one, two, three, four, five, etc. In one embodiment of the invention, the lighting source 100 includes a switching portion 140 and battery housing 150.

In one embodiment of the invention, the lighting source 100 includes a flexible arm 130. In one example, the flexible arm 130 is bendable and movable providing the lighting source body 120 to be rotated 360 degrees in three dimensions, and moved to any desired position (e.g., facing down, facing at an angle, facing up, etc.) for providing light in any desired direction when the lighting source 100 is powered on via a switch 140. In another example, once the extension arm 130 is moved or placed in a desired position, the extension arm 130 remains in the placed position until moved or placed in another position.

In one example, the extension arm 130 may be made of vinyl covered spring steel and have a length ranging from 100 mm to 150 mm, preferably about 137 mm. In one embodiment of the invention, the extension arm 130 may include threads for attaching to the housing 110 and the coupling portion 125. In other embodiments, the extension arm 130 may be permanently attached to the housing 110 and the coupling portion 125. In one example, the extension arm 130 has a length greater than the length of the housing 110.

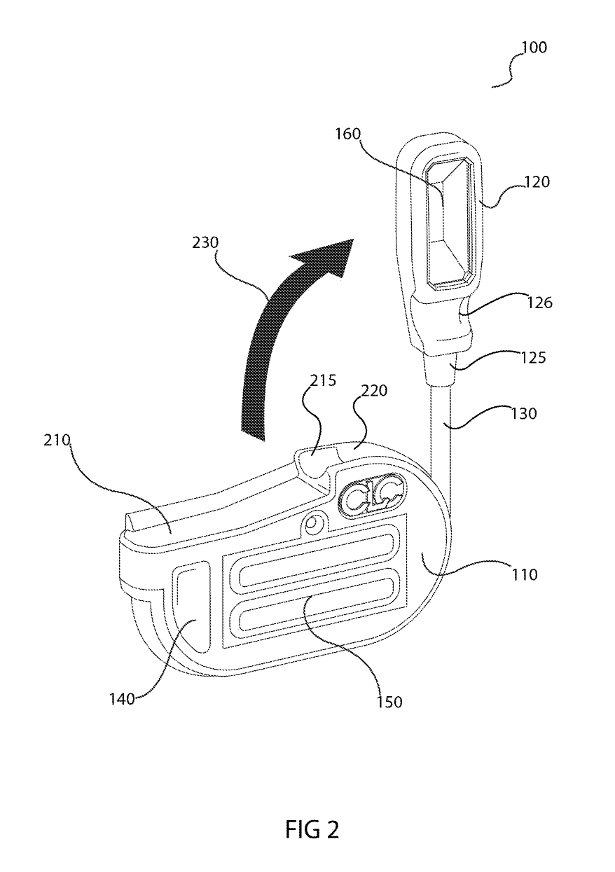

FIG. 2 illustrates the lighting source 100 placed or moved to a desired position in the direction of arrow 230 according to one embodiment of the invention. In one embodiment of the invention, the lighting source housing 110 includes a lighting source body placement portion 210 sized to fit and hold the light source body 120. In one example, the lighting source housing 110 further includes a groove or channel 220 having a diameter sized to hold the extension arm 130 within the groove 220. In this example, at one end of the groove 220, the lighting source housing 110 includes a coupling portion groove 215 having a diameter sized to hold the coupling portion 125 within the coupling portion groove 215. In one example, the lighting source housing 120 snaps into the lighting source body placement portion 210 to prevent dislodging the lighting source housing 120. In another example, the coupling portion 125 snaps into the coupling portion groove 215 to prevent dislodging the lighting source housing 120.

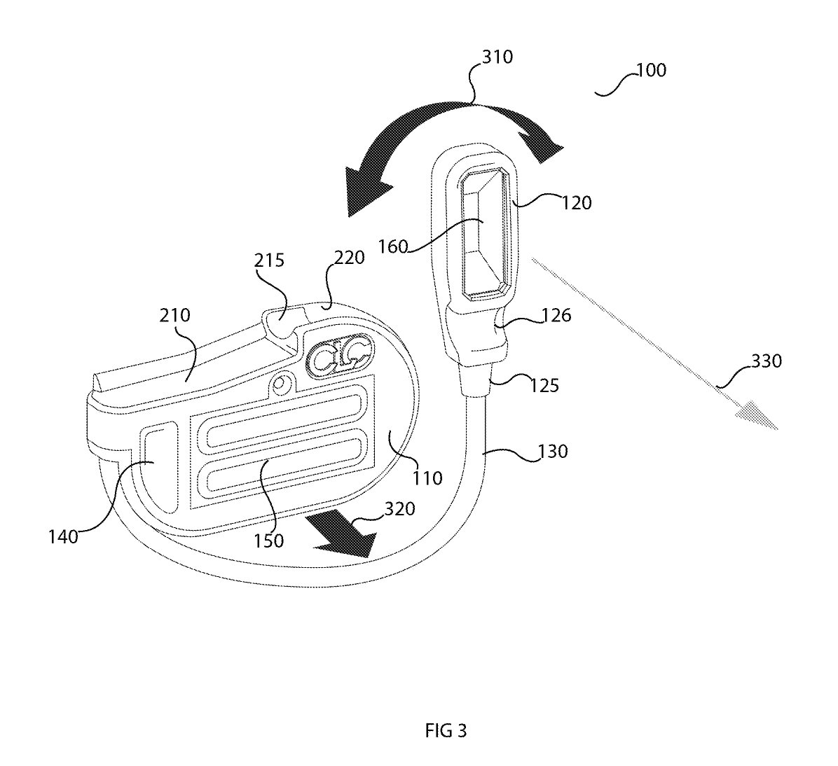

FIG. 3 illustrates a perspective view of the lighting source 100 that has the lighting source housing 120 rotated in the direction of the arrow 310 and the flexible arm 130 is moved away from the groove 220 in the direction of arrow 320 to provide light in the direction of the arrow 330 according to one embodiment of the invention. In one example, the lighting element 160 may comprise any combination of colored lighting, such as white, red, green, yellow, infrared, etc.

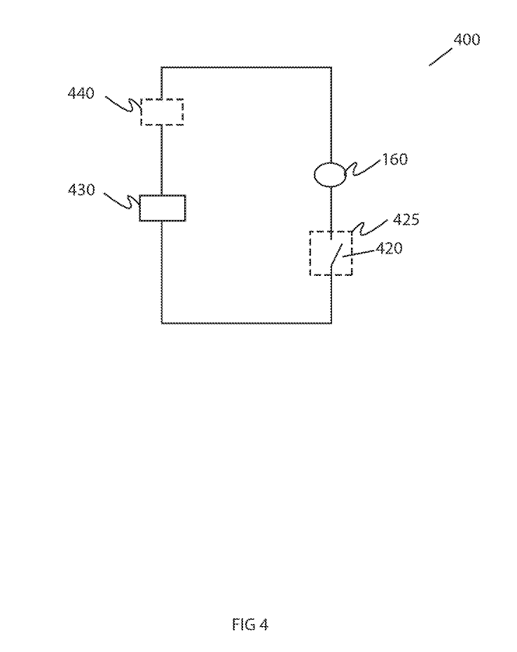

FIG. 4 illustrates a circuit 400 for the lighting according to one embodiment of the invention. In one embodiment of the invention, the circuit 400 for the lighting source 100 includes the lighting element 160, a switch 420 operated by the switching portion 140, a power source 430 and optional sensor 440. In one example, the switch 420 may comprise a slide switch, a push button switch, a touch switch, etc. In one example, the switch 420 is coupled with the switching portion 140 on the lighting source housing 110.

In one embodiment of the invention, the switch 420 may comprise a user lighting selection functionality for controlling a desired light intensity from the lighting element 160 by means of a controller circuit 425. In one example, the switch 420 and controller circuit 425 may be user selectable to light only a portion of LEDs of the lighting element 160 (e.g., one, two, three, all, etc.). In another example, the switch 420 and controller circuit 425 may be user selectable to select a particular color of LEDs of the lighting element 160 (e.g., white, red, green, yellow, etc.). In yet another example, the switch 420 and controller circuit 425 may be user selectable to select solid or blinking LEDs of the lighting element 160.

In one example, the sensor 440 may comprise a position determining sensor, a motion sensor, a light sensor, or any combination of various sensors to provide control of the switch 420. In one example, upon employing a position determining sensor as sensor 440, moving the lighting source body 120 (e.g., a positioning the lighting source body 120 away from the lighting source body holder 210) closes the switch 420, which provides voltage to the lighting element 160 from power source 430, and moving the lighting source body 120 back to the lighting source body holder 210 opens the switch 420 cutting off voltage from the power source 430 to the lighting element 160.

In one example, upon employing a motion sensor as sensor 440, a timer regulates the time that the switch 420 is closed based on sensing motion within a predetermined distance from this sensor 440 disposed on the housing 110. In one embodiment of the invention, the predetermined motion sensing distance is adjustable by a user from 1 ft.-15 ft. In another embodiment of the invention, the predetermined motion sensing distance is preset between distances of 1 ft-3 ft. In one example, the motion sensor may be turned on or off so that the switch 420 may be manually set on/off. In one embodiment of the invention, the timer may be user adjustable or preset to a particular amount of time. In one example, the timer may be adjusted from 5 seconds to 15 minutes. In another example, the timer is preset between 30 seconds and one minute. The use of the motion sensor provides lighting in the set direction of the lighting source body 120 by sensing motion without a user having to manually activate the switch 420.

In one example, upon employing a light sensor as sensor 440, when the switch 420 is placed in an on position, the sensor 440 will not close the circuit 400 unless the sensor 440 senses that not enough light is within the proximity of the light sensor (i.e., the area is dark enough to necessitate lighting the area). In one example, the light sensor 440 may be positioned on the sides, front or back portions of the housing 110. In one example, employing the light sensor 440 provides energy saving when lighting the lighting source 100 is not necessary based on available ambient light. In one example, the light sensor 440 may be manually overridden.

In one example, the sensor 440 may include any combination of sensors, such as motion and light sensors, position and light sensors, etc.

In one embodiment of the invention, the power source 430 comprises rechargeable or non-rechargeable batteries selected based on the number of LEDs and/or voltage required to power the lighting element 160. In one example, a solar charging circuit is employed to store energy in a rechargeable battery of power source 430. In one example, the solar charging circuit may be disposed on the outer portion of the housing 110. In another example, an adapter or plug in socket may be employed with the lighting source 100 to connect to an external power source, such as a battery pack from an electric tool (e.g., electric drill, hammer, screwdriver, etc.), separate additional battery pack, an AC/DC power supply, etc.

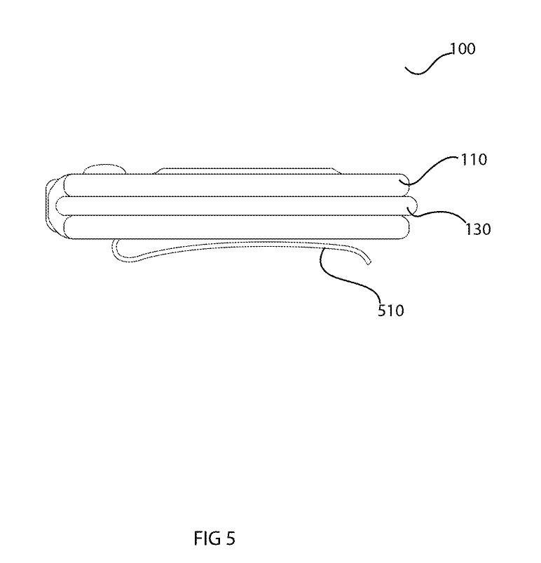

FIG. 5 illustrates a bottom view of the lighting source 100 including an attachment clip 510 according to another embodiment of the invention. As illustrated, the attachment clip 510 includes an opening between the attachment clip 510 and a rear portion of the housing 110, which provides for sliding the lighting source 100 onto an item, such as support suspenders, a utility bag, a belt, etc. In one embodiment of the invention, the attachment clip 510 may be made of a metal, metal alloy, acrylonitrile butadiene styrene (ABS), or any other similar material.

In one embodiment of the invention, the lighting source 100 may vary in size. In one example, width of the lighting source 100 may range from 40 mm to 60 mm, preferably 52 mm; the length of the lighting source 100 may range from 60 mm to 90 mm, preferably 81 mm; and the height of the lighting source 100 may range from 15-40 mm, preferably 20 mm It should be noted that the lighting source 100 may be customized according to necessity and desire of the user.

In other examples, other types of light sources may be employed with lighting element 160, such as Electroluminescent (EL) light sources, etc. In one embodiment of the invention, the lighting source 100 includes glow-in-the-dark material.

In one example, the lighting source 100 may be made of one or more of: ABS, reinforced polypropylene, polypropylene, high-density polyethylene, nylon material, hardened plastic, polymer, rubber, composite material, metal or metal alloy, etc., or other similar or equivalent materials.

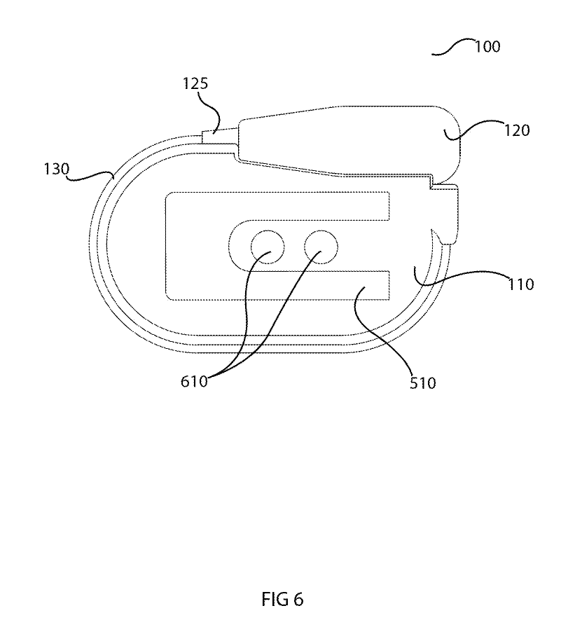

FIG. 6 illustrates a rear view of lighting source 100 including the attachment clip 510 according to another embodiment of the invention. In one embodiment of the invention, the attachment clip 510 may be attached to the housing 110 with fasteners 610 (e.g., rivets, screws, pins, welds, etc.). In one example, the attachment clip 510 is permanently attached to the housing 110. In another example, the attachment clip 510 is removably attached to the housing 110. In one embodiments of the invention, other means for attaching the housing 110 to an item may be employed, such as other attachment type clips, hook and loop fasteners, locking pins, etc.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A lighting device comprising:
at least one light source;
a flexible arm coupled to the light source; and
a light source body coupled to the flexible arm, wherein the light source body rotates for multi-positional lighting.

2. The lighting device of claim 1, wherein the light source comprises at least one light emitting diode.

3. The lighting device of claim 2, further comprising a switch device coupled to a power source and the light source.

4. The lighting device of claim 3, wherein the switch device comprises a sensor device.

5. The lighting device of claim 3, further comprising:
a housing including a light source body placement portion.

6. The lighting device of claim 5, further comprising an arm channel, wherein the flexible arm is removably coupled to the arm channel.

7. The lighting device of claim 6, wherein the housing comprises an attachment clip.

8. The lighting device of claim 7, wherein one end of the flexible arm is coupled to the housing.

9. The lighting device of claim 8, wherein the light source body includes a gripping groove portion.

10. A lighting system comprising:
a light source;
a switch device coupled to the light source;
a power source coupled to the switch;
a flexible extension arm coupled to the light source; and
a light source body coupled to the flexible arm, wherein the light source body rotates for multi-positional lighting.

11. The lighting system of claim 10, wherein the light source comprises at least one light emitting diode.

12. The lighting system of claim 10, wherein the switch device comprises a sensor device.

13. The lighting system of claim 10, further comprising:
a housing including a light source body placement portion.

14. The lighting system of claim 13, further comprising an arm channel, wherein the flexible extension arm is removably coupled to the arm channel

15. The lighting system of claim 14, wherein an attachment clip is coupled to the housing.

16. The lighting system of claim 14, wherein one end of the flexible extension arm is coupled to the housing.

17. The lighting system of claim 16, wherein the light source body includes a gripping portion.

18. The lighting system of claim 10, wherein the flexible extension arm has a length greater than the length of the housing.

19. The lighting system of claim 18, wherein the flexible extension arm is bendable.

20. The lighting system of claim 19, further comprising a light source body coupling portion, wherein one end of the arm channel includes a coupling portion groove.
